(19) United States
(12) Patent Application Publication
(10) Pub. No.: US 2011/0150410 A1
(43) Pub. Date: Jun. 23, 2011

(54) Curable liquid composition, cured layer and coated optical fiber

(75) Inventors: Shuichi Sugawara, Tokyo (JP); Hiroshi Miyazawa, Tokyo (JP); Masahito Mase, Tokyo (JP); Takeo Shigemoto, Tokyo (JP)

(73) Assignees: DSM IP ASSETS B.V., Heerlen (NL); JSR CORPORATION, Tokyo (JP)

(21) Appl. No.: 12/929,834

(22) Filed: Feb. 18, 2011

Related U.S. Application Data
(63) Continuation of application No. 11/886,088, filed on Feb. 26, 2008, now abandoned.

(30) Foreign Application Priority Data
Mar. 11, 2005 (JP) 2005-68503

(51) Int. Cl. G02B 6/00; C09D 175/14; C08F 2/46

(52) U.S. Cl. 385/141; 524/588; 427/487

(57) ABSTRACT

A curable liquid resin optical fiber coating composition comprising 0.1 to 10 wt %, relative to the total weight of the composition, of an alkoxysilane compound (A) which does not contain a radically polymerizable functional group, and 0.01 to 1 wt %, relative to the total weight of the composition, of a hindered amine compound (B). This curable liquid resin composition produces a cured product that ensures a high n-value of the coated optical fiber and an excellent fiber strength after coating removal.

### FIELD OF THE INVENTION

The present invention relates to a curable liquid resin composition that, when cured by radiation, provides a cured coating that ensures a high n-value of the coated fiber and an excellent fiber strength after coating removal. The present invention also relates to an optical fiber coated by said composition and a method of making said coated optical fiber.

### PRIOR ART

An optical fiber is produced by spinning molten glass to obtain a glass fiber and applying a resin to the glass fiber for protection and reinforcement. As the resin coating, a structure is known in which a flexible coating layer (hereinafter also referred to as “primary coating layer”) is provided on the surface of the glass fiber, and a rigid coating layer (hereinafter also referred to as “secondary coating layer”) is provided on the primary coating layer. An optical fiber ribbon is also known in which resin-coated optical fibers are placed side-by-side and bundled with a bundling material. A resin composition for forming the primary coating layer is called a primary material, a resin composition for forming the secondary coating layer is called a secondary material, and a resin composition used as the bundling material for the optical fiber ribbon is called a ribbon matrix material. The resin coating is generally formed by applying a curable liquid resin composition to an application target and curing the composition by applying heat or light, in particular, ultraviolet rays.

As a silane coupling agent, an alkoxysilane compound or the like has been used for such a curable liquid resin composition. The alkoxysilane compound may bond to a defective portion of the fiber via a hydrogen bond, and then undergo hydrolysis and condensation to repair the defective portion, thereby improving fiber strength.

Therefore, an optical fiber having a coating layer formed of a cured film of such a curable liquid resin composition has a high strength (n-value) insofar as the coating is provided. However, the fiber strength is significantly reduced after removing the coating. Specifically, since a generally-used coating material contains a radically polymerizable alkoxysilane compound, an amine compound used as a condensation catalyst is removed together with the radically polymerizable alkoxysilane compound when removing the coating. As a result, the fiber strength is reduced.

Patent document 1 discloses a curable resin composition containing tetraethoxysilane. However, this curable resin composition is a precoating metal paint composition for domestic electric appliances and construction materials, and differs in the curing manner and application from those of the present invention. Moreover, the patent document 1 does not disclose a hindered amine compound used in the present invention, the n-value, or the fiber strength after coating removal.

Patent document 2 discloses a curable liquid resin composition using tetraethoxysilane as an alkoxysilane compound which is not radically polymerizable. This curable liquid resin composition exhibits excellent storage stability and produces a cured product exhibiting excellent adhesion. However, since the composition does not include a hindered amine compound, the fiber strength after coating removal is reduced.

Patent document 3 discloses an optical fiber coating material using a hindered piperidine derivative as a thermal stabilizer. However, the patent document 3 does not describe use of an alkoxysilane compound, the n-value, or the fiber strength after coating removal.
[Patent Document 1] Japanese Patent Application Laid-open No. 10-88010
[Patent Document 2] Japanese Patent Application Laid-open No. 2005-36192
[Patent Document 3] Japanese Patent Application Laid-open No. 2-18409

### PROBLEMS TO BE SOLVED BY THE INVENTION

An object of the present invention is to provide a curable liquid resin composition which, when coated and cured on the optical fiber, ensures a high n-value of the fiber and excellent fiber strength after coating removal.

### MEANS FOR SOLVING THE PROBLEM

The inventors of the present invention conducted extensive studies in view of the above-described situation. As a result, the inventors have found that combined use of an alkoxysilane compound which does not contain a radically polymerizable functional group and a hindered amine compound at a specific proportion can produce a curable liquid resin composition which can produce a cured product ensuring a high n-value and ensures excellent fiber strength after coating removal. This finding has led to the completion of the present invention.

Specifically, the present invention provides a curable liquid resin optical fiber coating composition comprising 0.1 to 10 wt %, relative to the total weight of the composition, of an alkoxysilane compound (A) which does not contain a radically polymerizable functional group, and 0.01 to 1 wt %, relative to the total weight of the composition, of a hindered amine compound (B).

The present invention also provides an optical fiber coating layer obtained by curing the curable liquid resin composition using radiation, and an optical fiber including the coating layer.

The present invention also provides a method of making a coated optical fiber comprising the steps of preparing a composition of the present invention, coating this composition onto the optical fiber or another optical fiber coating layer, and curing the composition using radiation.

### EFFECT OF THE INVENTION

The curable liquid resin composition of the present invention can produce a cured product ensuring a high n-value and ensures excellent fiber strength after coating removal. The curable liquid resin composition is useful as an optical fiber coating material, particularly as a primary material, a surface coating material for various optical parts, an optical adhesive, and the like.

### BEST MODE FOR CARRYING OUT THE INVENTION

### I. Alkoxysilane Compound

The alkoxysilane compound (A) used in the curable liquid resin composition of the present invention does not contain a radically polymerizable functional group such as an ethylenically unsaturated bond. Therefore, the alkoxysilane compound can easily move inside the cured product obtained by curing the composition using ultraviolet rays to approach a defective portion of glass. Moreover, the alkoxysilane compound can bond to the defective portion of glass via a chemical reaction due to the presence of the alkokysilane portion, whereby the defective portion can be repaired.

As examples of the alkoxysilane compound, tetraethoxysilane (ethyl orthosilicate manufactured by Tama Chemicals Co., Ltd.; AY43-101 manufactured by Dow Corning Toray Silicone Co., Ltd.), methyltrimethoxysilane (SZ6070 manufactured by Dow Corning Toray Silicone Co., Ltd.), methyltriethoxysilane (SZ6072 manufactured by Dow Corning Toray Silicone Co., Ltd.), methyltriphenoxysilane (Z-6721 manufactured by Dow Corning Toray Silicone Co., Ltd.), dimethyldimethoxysilane (AY43-004 manufactured by Dow Corning Toray Silicone Co., Ltd.), trimethylmethoxysilane (AY43-043 manufactured by Dow Corning Toray Silicone Co., Ltd.), hexamethyldisilazane (Z-6079 manufactured by Dow Corning Toray Silicone Co., Ltd.), n-propyltrimethoxysilane (Z-6265 manufactured by Dow Corning Toray Silicone Co., Ltd.), isobutyltrimethoxysilane (AY43-048 manufactured by Dow Corning Toray Silicone Co., Ltd.), isobutyltrimethoxysilane (Z-6403 manufactured by Dow Corning Toray Silicone Co., Ltd.), n-hexyltrimethoxysilane (AY43-206M manufactured by Dow Corning Toray Silicone Co., Ltd.), n-hexyltriethoxysilane (AY43-206E manufactured by Dow Corning Toray Silicone Co., Ltd.), cyclohexylmethyldimethoxysilane (SZ6187 manufactured by Dow Corning Toray Silicone Co., Ltd.), n-octyltriethoxysilane (Z-6341 manufactured by Dow Corning Toray Silicone Co., Ltd.), n-decyltrimethoxysilane (AY43-210MC manufactured by Dow Corning Toray Silicone Co., Ltd.), 1,6-bis(trimethoxysilyl)hexane (AY43-083 manufactured by Dow Corning Toray Silicone Co., Ltd.), phenyltrimethoxysilane (AY43-040 manufactured by Dow Corning Toray Silicone Co., Ltd.), diphenyldimethoxysilane (AY43-047 manufactured by Dow Corning Toray Silicone Co., Ltd.), trifluoropropyltrimethoxysilane (AY43-013 manufactured by Dow Corning Toray Silicone Co., Ltd.), perfluorooctylethyltriethoxysilane (AY43-158E manufactured by Dow Corning Toray Silicone Co., Ltd.), diphenyldimethoxysilane (AY43-047 manufactured by Dow Corning Toray Silicone Co., Ltd.), 3-(2-aminoethyl)aminopropyltrimethoxysilane (SH6020 manufactured by Dow Corning Toray Silicone Co., Ltd.), 3-aminopropyltriethoxysilane (AY43-059 manufactured by Dow Corning Toray Silicone Co., Ltd.), 3-(2-aminoethyl)aminopropylmethyldimethoxysilane (SZ6023 manufactured by Dow Corning Toray Silicone Co., Ltd.), 3-anilinopropyltrimethoxysilane (SZ6083 manufactured by Dow Corning Toray Silicone Co., Ltd.), 3-ureidopropyltrimethoxysilane (AY43-031 manufactured by Dow Corning Toray Silicone Co., Ltd.), 3-glycidoxypropyltrimethoxysilane (SH6040 manufactured by Dow Corning Toray Silicone Co., Ltd.), 3-glycidoxypropylmethyldimethoxysilane (AY43-026 manufactured by Dow Corning Toray Silicone Co., Ltd.), bis[(triethoxysilyl)propyl]disulfide (Z-6920 manufactured by Dow Corning Toray Silicone Co., Ltd.), bis[(triethoxysilyl)propyl]tetrasulfide (Z-6940 manufactured by Dow Corning Toray Silicone Co., Ltd.), tetraethoxysilane condensate (Silicate 40, Silicate 45, Silicate 48 manufactured by Tama Chemicals Co., Ltd.), methyltrimethoxysilane condensate (M Silicate 51 manufactured by Tama Chemicals Co., Ltd.), tetrapropoxysilane (propylsilicate manufactured by Tama Chemicals Co., Ltd.), tetrabutoxysilane (butylsilicate manufactured by Tama Chemicals Co., Ltd.), and the like can be given.

As the component (A), a compound shown by the following general formula (1) is preferable:

(R¹)ₙ—Si—(OR²)₄₋ₙ (1)

wherein R¹ represents an alkyl group, an epoxyalkyl group, a perfluoroalkyl group, or an aryl group having 1 to 10 carbon atoms, R² represents an alkyl group having 1 to 6 carbon atoms, and n represents 0, 1, or 2. In particular, a methoxysilyl compound or an ethoxysilyl compound is preferable. More specifically, a methoxysilyl compound or an ethoxysilyl compound having two or more functional groups is preferable because such a compound exhibits excellent hydrolyzability and suffers from steric hindrance to only a small extent, whereby a reaction with a defective portion of glass can be facilitated.

The component (A) used in the curable liquid resin composition in the present invention may used either individually or in combination of two or more in an amount of 0.1 to 10 wt %, preferably 0.25 to 5 wt %, and particularly preferably 0.5 to 1 wt %. If the amount of the component (A) is within this range, a cured product ensuring a high n-value can be obtained, and excellent fiber strength can be obtained after coating removal.

### II. Hindered Amine Compound

The hindered amine compound (B) used in the present invention is basic and effective for hydrolysis and condensation of the alkoxysilane compound. Since the basicity of the hindered amine compound (B) is low, the hindered amine merely corrodes the defective portion of glass, whereby a decrease in the n-value can be prevented.

As examples of the component (B), di-sec-butylamine, diisopropylamine, 1,4-diazabicyclo[2.2.2]octane, 2,6,7-trimethyl-1,4-diazabicyclo[2.2.2]octane, bis(1,1,2,6,6-pentamethyl-4-piperidyl)sebacate (Sanol LS-765, Sanol LS-292 manufactured by Sankyo Lifetech Co., Ltd.), bis(2,2,6,6-tetramethyl-4-piperidyl)sebacate (Sanol LS-770 manufactured by Sankyo Lifetech Co., Ltd.), 1-[2-[3-(3,5-di-t-butyl-4-hydroxyphenyl)propionyloxy]ethyl]-4-[3-(3,5-di-t-butyl-hydroxyphenyl)propionyloxy]-2,2,6,6′-tetramethylpiperidine (Sanol LS-2626 manufactured by Sankyo Lifetech Co., Ltd.), 4-benzoyloxy 2,2,6,6-tetramethylpiperidine (Sanol LS-744 manufactured by Sankyo Lifetech Co., Ltd.), poly[[6-(1,1,3,3-tetramethylbutyl)amino-1,3,5-triazine-2,4-diyl][(2,2,6,6-tetramethyl-4-piperidyl)imino]hexamethylene[(2,2,6,6-tetramethyl-4-piperidyl)imino]] (Sanol LS-944 manufactured by Sankyo Lifetech Co., Ltd.), and the like can be given.

As the component (B), a hindered piperidine compound is preferable due to low basicity and strong steric hindrance. In particular, a secondary or a tertiary hindered piperidine compound is more preferable, with a tertiary hindered piperidine compound being particularly preferable. Since these compounds exhibit strong steric hindrance, these compounds do not react with an acid or an NCO group in the liquid resin, thereby exhibiting excellent storage stability. Of these compounds, bis(1,1,2,6,6-pentamethyl-4-piperidyl)sebacate and bis(2,2,6,6-tetramethyl-4-piperidyl)sebacate are preferable.

The component (B) used in the curable liquid resin composition of the present invention may be used either individually or in combination of two or more in an amount of 0.01 to 1 wt %, preferably 0.03 to 0.07 wt %, and particularly preferably 0.04 to 0.05 wt %. If the amount of the component (B) is within this range, a cured product ensuring a high n-value can be obtained, and excellent fiber strength can be obtained after coating removal.

The curable liquid resin composition of the present invention preferably further includes (C) a urethane (meth)acrylate, and

(D) a reactive diluent copolymerizable with the component (C).

### III. Urethane (meth)acrylate

There are no specific limitations to the urethane (meth)acrylate (C). For example, the urethane (meth)acrylate (C) may be obtained by reacting (a) a polyol compound, (b) a polyisocyanate compound, and (c) a hydroxyl group-containing (meth)acrylate compound.

As specific examples of the method for preparing the urethane (meth)acrylate (C), a method of reacting the polyol (a), polyisocyanate compound (b), and hydroxyl group-containing (meth)acrylate (c) all together; a method of reacting the polyol (a) and the polyisocyanate compound (b), and reacting the resulting product with the hydroxyl group-containing (meth)acrylate (c); a method of reacting the polyisocyanate compound (b) and the hydroxyl group-containing (meth)acrylate (c), and reacting the resulting product with the polyol (a); a method of reacting the polyisocyanate compound (b) and the hydroxyl group-containing (meth)acrylate (c), reacting the resulting product with the polyol (a), and reacting the resulting product with the hydroxyl group-containing (meth)acrylate (c); and the like can be given.

As examples of the polyol (a), polyether diols obtained by ring-opening polymerization of one type of ion-polymerizable cyclic compound such as polyethylene glycol, polypropylene glycol, polytetramethylene glycol, polyhexamethylene glycol, polyheptamethylene glycol, and polydecamethylene glycol, and polyether diols obtained by ring-opening copolymerization of two or more types of ion-polymerizable cyclic compounds can be given. As examples of the ion-polymerizable cyclic compounds, cyclic ethers such as ethylene oxide, propylene oxide, butene-1-oxide, isobutene oxide, oxetane, 3,3-dimethyloxetane, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate can be given. Polyether diols obtained by the ring-opening copolymerization of these ion-polymerizable cyclic compounds with cyclic imines such as ethyleneimine, cyclic lactonic acids such as γ-propiolactone or glycolic acid lactide, or dimethylcyclopolysiloxanes may be used. As specific examples of combinations of two or more ion-polymerizable cyclic compounds, combinations of tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of these ion-polymerizable cyclic compounds may be either a random copolymer or a block copolymer. Of these polyether diols, polypropylene glycol is preferable from the viewpoint of providing jelly resistance and water resistance to the cured product of the present invention. Polypropylene glycol with a polystyrene-reduced number average molecular weight determined by gel permeation chromatography (GPC) of 1000 to 7000 is particularly preferable.

As examples of commercially available products of these polyether diols, PTMG650, PTMG1000, PTMG2000 (manufactured by Mitsubishi Chemical Corp.), EXCENOL 1020, 2020, 3020, PREMINOL PML-4002, PML-5005 (manufactured by Asahi Glass Co., Ltd.), UNISAFE DC1100, DC1800, DCB1000 (manufactured by Nippon Oil and Fats Co., Ltd.), PPTG1000, PPTG2000, PPTG4000, PTG400, PTG650, PTG1000, PTG2000, PTG-L1000, PTG-L2000 (manufactured by Hodogaya Chemical Co., Ltd.), Z-3001-4, Z-3001-5, PBG2000 (manufactured by Daiichi Kogyo Seiyaku Co., Ltd.), ACCLAIM 2200, 2220, 3201, 3205, 4200, 4220, 8200, 12000 (manufactured by Lyondell), and the like can be given.

The above polyether diols are preferable as the polyol. In addition, a polyester diol, polycarbonate diol, polycaprolactone diol, and the like may also be used. These diols may be used in combination with the polyether diol. There are no specific limitations to the manner of polymerization of the structural units of these polyols, which may be any of random polymerization, block polymerization, or graft polymerization.

As examples of the polyisocyanate (b) used for synthesizing the urethane (meth)acrylate (C), aromatic diisocyanates, alicyclic diisocyanates, aliphatic diisocyanates, and the like can be given. There are no specific limitations to the polyisocyanate (b) insofar as the compound can be used in the optical fiber coating resin composition. As the polyisocyanate (b), aromatic diisocyanates and alicyclic diisocyanates are preferable, with 2,4-tolylene diisocyanate and isophorone diisocyanate being still more preferable. These diisocyanate compounds may be used either individually or in combination of two or more.

As the hydroxyl group-containing (meth)acrylate (c) used for synthesizing the urethane (meth)acrylate (C), a hydroxyl group-containing (meth)acrylate in which the hydroxyl group is bonded to a primary carbon atom (hereinafter called “primary hydroxyl group-containing (meth)acrylate”) and a hydroxyl group-containing (meth)acrylate in which the hydroxyl group is bonded to a secondary carbon atom (hereinafter called “secondary hydroxyl group-containing (meth)acrylate”) are preferable in view of reactivity with the isocyanate group of the polyisocyanate.

As examples of the primary hydroxyl group-containing (meth)acrylate, 2-hydroxyethyl (meth)acrylate, 4-hydroxybutyl (meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, and the like can be given.

As examples of the secondary hydroxyl group-containing (meth)acrylate, 2-hydroxypropyl (meth)acrylate, 2-hydroxybutyl (meth)acrylate, 2-hydroxy-3-phenyloxypropyl (meth)acrylate, 4-hydroxycyclohexyl (meth)acrylate, and the like can be given. Further examples include a compound obtained by the addition reaction of (meth)acrylic acid and a glycidyl group-containing compound such as alkyl glycidyl ether, allyl glycidyl ether, or glycidyl (meth)acrylate, or the like. These hydroxyl group-containing (meth)acrylate compounds may be used either individually or in combination of two or more.

The polyol (a), the polyisocyanate compound (b), and the hydroxyl group-containing (meth)acrylate used for synthesizing the urethane (meth)acrylate (C) are preferably used so that the isocyanate group included in the polyisocyanate compound and the hydroxyl group included in the hydroxyl group-containing (meth)acrylate are respectively 1.1 to 2 equivalents and 0.1 to 1 equivalent for one equivalent of the hydroxyl group included in the polyol.

In addition, diamines may be used for synthesizing the urethane (meth)acrylate (C) in combination with the polyol. As examples of such diamines, diamines such as ethylenediamine, tetramethylenediamine, hexamethylenediamine, p-phenylenediamine, and 4,4′-diaminodiphenylmethane, diamines containing a hetero atom, polyether diamines, and the like can be given.

A part of the hydroxyl group-containing (meth)acrylate may be replaced by a compound having a functional group which can be added to an isocyanate group or an alcohol. As examples of the compound having a functional group which can be added to an isocyanate group, γ-aminopropyltriethoxysilane, γ-mercaptopropyltrimethoxysilane, and the like can be given. Use of such a compound can further improve adhesion to a substrate such as glass. As examples of the alcohol, methanol, ethanol, isopropyl alcohol, n-butyl alcohol, t-butyl alcohol, and the like can be given. The Young's modulus of the resin can be adjusted by using such compounds.

In the synthesis of the urethane (meth)acrylate (C), it is preferable to use a urethanization catalyst such as copper naphthenate, cobalt naphthenate, zinc naphthenate, dibutyltin dilaurate, triethylamine, 1,4-diazabicyclo[2.2.2]octane, or 2,6,7-trimethyl-1,4-diazabicyclo [2.2.2]octane in an amount of 0.01 to 1 wt % of the total amount of the reactants. The reaction temperature is usually 5 to 90° C., and preferably 10 to 80° C.

The polystyrene-reduced number average molecular weight of the urethane (meth)acrylate (C) determined by GPC is usually 500 to 40,000, and preferably 700 to 30,000 in order to ensure good breaking elongation of the cured product and appropriate viscosity of the curable liquid resin composition.

The urethane (meth)acrylate (C) is included in the curable liquid resin composition of the present invention in an amount of preferably 35 to 85 wt %, and particularly preferably 55 to 65 wt % in order to ensure excellent mechanical characteristics (e.g. Young's modulus and breaking elongation) of the cured product and appropriate viscosity of the curable liquid resin composition. If the amount exceeds 85 wt %, since the Young's modulus of the cured product exceeds 2.0 MPa, such a composition is not suitable as an optical fiber coating resin. Moreover, since the viscosity of the curable liquid resin composition exceeds 6.0 Pa·s, workability is decreased. In addition, the water resistance of the cured product becomes poor. If the amount is less than 35 wt %, breaking strength deteriorates.

### IV. Reactive Diluent

The component (D) used in the curable liquid resin composition of the present invention is a reactive diluent copolymerizable with the component (C). As examples of the component (D), (D1) a polymerizable monofunctional compound or (D2) a polymerizable polyfunctional compound can be given. As examples of the polymerizable monofunctional compound (D1), vinyl group-containing lactams such as N-vinylpyrrolidone and N-vinylcaprolactam, alicyclic structure-containing (meth)acrylates such as isobornyl (meth)acrylate, bornyl (meth)acrylate, tricyclodecanyl (meth)acrylate, and dicyclopentanyl (meth)acrylate, benzyl (meth)acrylate, 4-butylcyclohexyl (meth)acrylate, acryloylmorpholine, vinylimidazole, vinylpyridine, and the like can be given. Further examples include 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, 2-hydroxy-3-phenoxypropyl acrylate, and a compound shown by the following general formula:

CH₂═C(R³)—COO(R⁴O)p—C₆H₄—R⁵

wherein R³ represents a hydrogen atom or a methyl group, R⁴ represents an alkylene group having 2 to 6, and preferably 2 to 4 carbon atoms, R⁵ represents a hydrogen atom or an alkyl group having 1 to 12, and preferably 1 to 9 carbon atoms, and p is an integer from 0 to 12, and preferably from 1 to 8.

Of these polymerizable monofunctional compounds (D1), vinyl group-containing lactams such as N-vinylpyrrolidone and N-vinylcaprolactam, monofunctional (meth)acrylate containing an aliphatic hydrocarbon group having 10 or more carbon atoms are preferable. The aliphatic group having 10 or more carbon atoms may be linear, branched, or alicyclic. The number of carbon atoms is preferably 10 to 24. Of these, isobornyl (meth)acrylate, isodecyl (meth)acrylate, and lauryl (meth)acrylate are preferable, with isobornyl (meth)acrylate and/or isodecyl (meth)acrylate being particularly preferable. As commercially available products of these polymerizable monofunctional compounds (D1), IBXA (manufactured by Osaka Organic Chemical Industry Co., Ltd.), Aronix M-110, M-111, M-113, M-114, M-117, TO-1210 (manufactured by Toagosei Co., Ltd.), Epoxy Ester M-600A (manufactured by Kyoeisha Chemical Co., Ltd.), or the like may be used.

There are no specific limitations to the polymerizable polyfunctional compound (D2) insofar as the compound can be used in the optical fiber coating resin composition.

As preferable examples of the polymerizable polyfunctional compound (D2), polyethyleneglycol diacrylate, tricyclodecanediyldimethylene di(meth)acrylate, di(meth)acrylate of ethylene oxide addition bisphenol A, tris(2-hydroxyethyl)isocyanurate tri(meth)acrylate, hexanediol diacrylate (HDDA), and the like can be given. As commercially available products of the polymerizable polyfunctional compound (D2), Light Acrylate 9EG-A, 4EG-A (manufactured by Kyoeisha Chemical Co., Ltd.), Yupimer UV, SA1002 (manufactured by Mitsubishi Chemical Corp.), Aronix M-215, M-315, M-325 (manufactured by Toagosei Co., Ltd.), and the like can be given.

The polymerizable monofunctional compound (D1) and the polymerizable polyfunctional compound (D2) may be used in combination.

The component (D) is used in the curable liquid resin composition of the present invention in an amount of preferably 1 to 60 wt %, and particularly preferably 2 to 45 wt %. If the amount is less than 1 wt %, curability may be impaired. If the amount exceeds 60 wt %, the coating shape may change due to low viscosity, whereby the application becomes unstable.

### V. Photoinitiator

A polymerization initiator (E) may optionally be added to the curable liquid resin composition of the present invention. As the component (E), a photoinitiator (E1) is usually used. A heat polymerization initiator (E2) may optionally be used in combination with the photoinitiator (E1).

As examples of the photoinitiator (E1), 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, and the like can be given. As commercially available products of these compounds, Irgacure 184, 369, 651, 500, 907, 819, CGI1700, CGI1850, CGI1870, CG2461, Darocur 1116, 1173 (manufactured by Ciba Specialty Chemicals K.K.), Lucirin TPO (manufactured by BASF), Ubecryl P36 (manufactured by UCB), and the like can be given.

As examples of the heat polymerization initiator (E2), a peroxide, an azo compound, and the like can be given. Specific examples include benzoyl peroxide, t-butyl-oxybenzoate, azobisisobutyronitrile, and the like.

When curing the curable liquid resin composition of the present invention using light, a photosensitizer may optionally be added in addition to the photoinitiator. As examples of the photosensitizer, triethylamine, diethylamine, N-methyldiethanoleamine, ethanolamine, 4-dimethyl aminobenzoic acid, methyl 4-dimethylaminobenzoate, ethyl 4-dimethylaminobenzoate, isoamyl 4-dimethylaminobenzoate, and the like can be given. As commercially available products of the photo sensitizer, Ubecryl P102, 103, 104, 105 (manufactured by UCB), and the like can be given.

The polymerization initiator (E) is used in the curable liquid resin composition of the present invention in an amount of preferably 0.1 to 10 wt %, and particularly preferably 0.5 to 5 wt %.

### VI. Additives

Additives such as coloring agents, light stabilizers, silane coupling agents, antioxidant, heat polymerization inhibitors, leveling agents, surfactants, preservatives, plasticizers, lubricants, solvents, fillers, aging preventives, wettability improvers, and coating surface improvers may be added to the curable liquid resin composition of the present invention in addition to the above-described components. As examples of light stabilizers, Tinuvin 292, 144, 622LD (manufactured by Ciba Specialty Chemicals K.K.), Sanol LS770 (manufactured by Sankyo Co., Ltd.), Seesorb 101, Seesorb 103, Seesorb 709 (manufactured by Shipro Kasei Kaisha, Ltd.), Sumisorb 130 (manufactured by Sumitomo Chemical Industries Co., Ltd.), and the like can be given. As examples of silane coupling agents, γ-aminopropyltriethoxysilane, γ-mercaptopropyltrimethoxysilane, gmma-methacryloxypropyltrimethoxysilane, commercially available products such as SH6062, 6030 (manufactured by Dow Corning Toray Co., Ltd.), KBE903, 603, 403 (manufactured by Shin-Etsu Chemical Co., Ltd.), and the like can be given. As examples of antioxidants, Sumilizer GA-80 (manufactured by Sumitomo Chemical Industries Co., Ltd.), Irganox 1010, 1035 (manufactured by Ciba Specialty Chemicals K.K.), and the like can be given.

The viscosity (at 25° C.) of the curable liquid resin composition of the present invention is preferably 1.0 to 6.0 Pa·s. The Young's modulus of the cured product is preferably 0.1 to 2.0 MPa when used as an optical fiber primary layer.

The curable liquid resin composition of the present invention is cured using radiation. Radiation used herein refers to infrared radiation, visible rays, ultraviolet rays, X-rays, α-rays, β-rays, γ-rays, electron beams, and the like. Of these, ultraviolet rays are particularly preferable.

Another aspect of the present invention provides an optical fiber coating layer produced by applying the above-described curable liquid resin composition to a glass fiber or another optical fiber coating layer, and curing the curable liquid resin composition using radiation. When using ultraviolet rays as the radiation, the ultraviolet rays are preferably applied at a dose of 50 to 300 J/cm². The optical fiber coating layer of the present invention forms a part or the entirety of the fiber coating layer. The optical fiber coating layer of the present invention preferably forms an optical fiber primary coating layer.

Still another aspect of the present invention provides an optical fiber having the above-described optical fiber coating layer. In the optical fiber, the above-described optical fiber coating layer forms an arbitrary layer. A preferable optical fiber is an optical fiber in which the above-described optical fiber coating forms a primary coating layer and a secondary coating layer is provided over the primary coating layer, or an optical fiber ribbon in which a number of optical fibers are bundled using a bundling material. The optical fiber of the present invention is obtained by melting quartz to obtain a glass fiber, applying a primary coating material to the glass fiber and curing the primary coating material by applying radiation, applying a secondary coating material over the cured primary coating material, and curing the secondary coating material by applying radiation.

### EXAMPLES

The present invention is described below in more detail by way of examples. However, the present invention is not limited to the following examples.

### Synthesis Example 1

### Synthesis of urethane (meth)acrylate)

A reaction vessel equipped with a stirrer was charged with 50.700 parts of polypropylene glycol with a number average molecular weight of 2000 (NPML-2002A manufactured by Asahi Glass Urethane Co., Ltd.), 6.739 parts of toluene diisocyanate, and 0.014 parts of 2,6-di-t-butyl-p-cresol. The mixture was cooled to 15° C. with stirring. After the addition of 0.044 parts of dibutyltin dilaurate, the mixture was gradually heated to 40° C. in one hour with stirring. The mixture was then further heated to 45° C. and allowed to react. After the residual isocyanate group concentration decreased to 1.49 wt % or less (percentage with respect to the amount added), 0.300 parts of mercaptopropyltrimethoxysilane (SH6062 manufactured by Dow Corning Toray Co., Ltd.) was added. The mixture was then stirred at about 50° C. for two hours. After the addition of 2.010 parts of 2-hydroxyethyl acrylate, the mixture was allowed to react at about 55° C. for one hour with stirring. After the addition of 0.251 parts of methanol, the mixture was stirred at about 60° C. for one hour. The reaction was terminated when the residual isocyanate group concentration became 0.05 wt % or less. The urethane (meth)acrylate obtained is referred to as “Oligomer A”.

### Examples 1 and 2 and Comparative Examples 1 to 6

### Preparation of Primary Coating Material

A reaction vessel equipped with a stirrer was charged with the compounds listed in Table 1 at a ratio in parts by weight shown in Table 1. The mixture was stirred at 50° C. until a homogeneous solution was obtained, thus obtaining curable liquid resin compositions of the examples and the comparative examples.

### Synthesis Example 2

### Preparation of Secondary Coating Material

A reaction vessel equipped with a stirrer was charged with 15.429 parts of isophorone diisocyanate, 0.013 parts of 2,6-di-t-butyl-p-cresol, and 0.047 parts of dibutyltin dilaurate. The mixture was cooled with ice to 10° C. or less with stirring. After the dropwise addition of 11.32 g of hydroxyethyl acrylate while controlling the temperature at 20° C. or less, the mixture was allowed to react for one hour with stirring. After the addition of 25.40 g of polytetramethylene glycol with a number average molecular weight of 1,000 and 9.36 g of alkylene oxide addition diol of bisphenol A with a number average molecular weight of 400, the mixture was stirred at 70 to 75° C. for three hours. The reaction was terminated when the residual isocyanate group concentration became 0.1 wt % or less. The mixture was then cooled to 50 to 60° C. After the addition of 9.70 g of isobornyl acrylate, 14.55 g of SA-1002 (manufactured by Mitsubishi Chemical Corp.), 9.70 g of N-vinylcaprolactam, 2.91 g of Irgacure 184 (manufactured by Ciba Specialty Chemicals K.K.), and 0.3 g of Sumilizer GA-80 (manufactured by Sumitomo Chemical Industries Co., Ltd.), the mixture was stirred until a homogeneous liquid resin was obtained, thereby obtaining a curable liquid resin composition.

### Test Example

### (1) Residual Amine Compound Content after Acceleration Test

The amine values of the compositions obtained in examples and comparative examples before and after acceleration test were measured. Specifically, 1 g of the resin composition was dissolved in 2-propanol (40 mL) and ultrapure water (10 mL). The amine value (hereinafter called “initial amine value”) of the resulting solution was calculated by titration with a 0.1 N hydrochloric acid aqueous solution using a potentiometric titrator (COM-2000 manufactured by Hiranuma Sangyo Co., Ltd.). After allowing the resin composition to stand at 40° C. for 14 days, the amine value of the composition was measured again (hereinafter called “amine value after the acceleration test”). The residual amine compound content was computed using the following equation (1) to determine the residual amine compound content after the acceleration test.

Amine compound residual ratio after acceleration test (%)=100−(amine value after acceleration test/initial amine value)×100 (1)

### (2) Fiber Strength

### (2-1) Production of Optical Fiber:

The composition of the examples or the comparative examples was applied to and cured on a quartz glass fiber as a primary coating material using optical fiber drawing equipment (manufactured by Yoshida Kogyo Co., Ltd.). A secondary coating material (DeSolite 83203 manufactured by JSR Corporation) was then applied to the resulting fiber and cured. The optical fiber production conditions were as follows.

The diameter of the glass fiber was 125 μm. The primary coating material was applied to and cured on the glass fiber to adjust the diameter of the resulting optical fiber to 200 μm. The secondary coating material was applied to the primary coating material so that the diameter of the optical fiber became 250 μm after curing the secondary coating material. A UV lamp (SMX 3.5 kw manufactured by ORC) was used as a UV irradiation apparatus. The optical fiber drawing rate was 200 m/min.

(2-2) Measurement of n-Value

The optical fiber obtained in (2-1) was stored at a temperature of 23° C. and a humidity of 50% for two weeks. The n-value of the optical fiber was measured according to TIA/EIA (ITM-13; Telecommunication Industry Association, Electronic Industries Alliance; TELECOMMUNICATIONS SYSTEMS BULLETIN 62-13) using a two-point bending machine (TP-2 manufactured by FiberSigma).

(2-3) Measurement of Fiber Strength after Coating Removal:

The fiber strength of the optical fiber obtained in (2-1) after coating removal was measured. The coating was removed from the optical fiber at a temperature of 23° C. and a humidity of 50% using a coating removal jig (NO-NIK wire stripper). The optical fiber in which the glass was exposed was subjected to a tensile test using a tensile tester (AGS-50G manufactured by Shimadzu Corporation) according to the TIA/EIA (ITM-13) tensile method. The tensile rate was 100 μm/s. The stress at which the optical fiber broke was calculated to determine the fiber strength after coating removal.

### (3) Evaluation

An optical fiber of which the residual amine compound content after the acceleration test was 80% or more, the n-value was 20 or more, and the fiber strength after coating removal was 1.0 GPa or more was determined as “Good”. The results are shown in Table 1.

TABLE 1

| | Example | | Comparative Example | | | | | |
|---|---|---|---|---|---|---|---|---|
| Component (parts by weight) | 1 | 2 | 1 | 2 | 3 | 4 | 5 | 6 |
| Oligomer A | 60 | 60 | 60 | 60 | 60 | 60 | 60 | 60 |
| Aronix M-113 | 30 | 30 | 30 | 30 | 30 | 30 | 30 | 30 |
| N-Vinylcaprolactam | 6 | 6 | 6 | 6 | 6 | 6 | 6 | 6 |
| 1,6-Hexane diacrylate | 1 | 1 | 1 | 1 | 1 | 1 | 1 | 1 |
| Lucirin TPO-X | 1.3 | 1.3 | 1.3 | 1.3 | 1.3 | 1.3 | 1.3 | 1.3 |
| Sumilizer GA-80 | 0.6 | 0.6 | 0.6 | 0.6 | 0.6 | 0.6 | 0.6 | 0.6 |
| SZ6030* | — | — | — | — | 1 | — | — | — |
| Ethyl orthosilicate | 1 | 1 | — | 15 | — | 1 | 1 | 1 |
| Sanol LS-770 | 0.05 | — | — | — | — | — | — | — |
| Sanol LS-765 | — | 0.05 | 0.05 | 0.05 | 0.05 | — | 1.5 | — |
| Diethylamine | — | — | — | — | — | — | — | 0.05 |
| Residual amine compound content after acceleration test (%) | 80 | 99 | 98 | 96 | 99 | — | 97 | 69 |
| n-value | 20 | 20 | 20 | 18 | 19 | 21 | 17 | 18 |
| Fiber strength after coating removal (GPa) | 1.5 | 1.5 | <0.8 | <0.8 | <0.8 | <0.8 | 1.8 | 1.8 |
| Evaluation | Good | Good | Bad | Bad | Bad | Bad | Bad | Bad |

*: 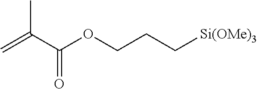
Lucirin TPO-X: 2,4,6-trimethylbenzoyldiphenylphosphine oxide (manufactured by BASF Japan Ltd.)
Sumilizer GA-80: 3,9-bis[2-[3-(3-t-buty1-4-hydroxy-5-methylphenyl)propionyloxy]-1,1-dimethylethyl]-2,4,8,10-tetraoxaspiro[5,5]undecane (manufactured by Sumitomo Chemical Co., Ltd.)

1. A curable liquid resin optical fiber coating composition comprising:
0.1 to 10 wt %, relative to the total weight of the composition, of an alkoxysilane component (A) which does not contain radically polymerizable functional group;
0.01 to 1 wt %, relative to the total weight of the composition, of a hindered amine component (B);
55 to 65 wt %, relative to the total weight of the composition, of a urethane (meth)acrylate component (C) with a number average molecular weight of 500 to 40,000; and
1 to 60 wt %, relative to the total weight of the composition, of a reactive diluent component (D) copolymerizable with the component (C).

2. (canceled)

3. The composition according to claim 1, wherein the component (A) is an alkoxysilane compound shown by the following general formula (1),
(R¹)ₙ—Si—(OR²)₄₋ₙ (1)
wherein R¹ represents an alkyl group, an epoxyalkyl group, a perfluoroalkyl group, or an aryl group having 1 to 10 carbon atoms, R² represents an alkyl group having 1 to 6 carbon atoms, and n represents 0, 1, or 2.

4. The composition according to claim 1, wherein the component (A) is ethyl orthosilicate.

5. The composition according to claim 1, wherein the component (B) is a hindered piperidine compound.

6. The composition according to claim 1, wherein the component (B) is bis(2,2,6,6-tetramethyl-4-piperidyl)sebacate.

7. The composition according to claim 1, wherein said composition has a residual amine compound content of 80% or more after an acceleration test.

8. An optical fiber coating layer obtained by curing the composition according to claim 1 using radiation.

9. An optical fiber comprising the coating layer according to claim 8.

10. The optical fiber according to claim 9, wherein said optical fiber has an n-value of 20 or more.

11. The optical fiber according to claim 9, wherein said optical fiber has a fiber strength of 1.0 GPa or more after coating removal.

12. A method of producing a coated optical fiber comprising:
a) preparing a composition according to claim 1;
b) coating the composition onto the optical fiber or another optical fiber coating layer;
c) curing the composition using radiation.

13. A curable liquid resin optical fiber coating composition of claim 1 wherein said urethane (meth)acrylate component (C) has a number average molecular weight of 700 to 30,000.
